(19) United States
(12) Patent Application Publication
(10) Pub. No.: US 2003/0050999 A1
(43) Pub. Date: Mar. 13, 2003

(54) System product and method for CD ROM business cards

(76) Inventor: Walter Charnoff, Fairfield, CA (US)

Correspondence Address: Risto A. Rinne, Jr., Suite E, 2173 East Francisco Blvd., San Rafael, CA, 94901, US

(21) Appl. No.: 09/948,518

(22) Filed: Sep. 7, 2001

(51) Int. Cl. G06F 15/16; G06F 15/177

(52) U.S. Cl. 709/218; 709/220

(57) ABSTRACT

A generic type of a CD ROM business card includes a generic sales presentation for a parent company that is played over a personal computer and seen by a user of the card. At the conclusion of the presentation, the user is vectored to a home page over the Internet. The home page is maintained by a Service Provider. At the home page, the user enters a unique number that includes an ID number for an employee of the parent company. After entry of the ID number, the Service Provider verifies that the ID number is valid for the parent company and that the employee remains in good standing, after which time the user is vectored to a second address that includes a WEB site of the employee. Accordingly, significant problems of creating generic CD ROM business cards are solved whereby large quantities of them can be purchased and maintained over time as new employees are hired or others terminated. A system to utilize the CD ROM business cards and method for making them are also disclosed.

### BACKGROUND OF THE INVENTION

1. Field of the Invention

The present invention, in general relates to CD ROM disks and, more particularly, to CD ROM business cards including products and methods for encoding and for optimally using personalized CD ROM business cards and to systems that govern their utilization.

Representatives working for many industries use CD ROM business cards to attract clients to the firm they work for. They may want to attract them, in particular, to their own, personal WEB site for certain reasons, especially when commissions are involved.

Clearly, a company representative will not want to go through the expense of obtaining CD ROM business cards and then distributing those cards to potential clients who, when they use them, avoid dealing with the representative who handed them the card in the first place. Representatives would not want to distribute the CD cards if prospective clients are able to access other representatives who also work for or represent the products and services of the parent firm.

Therefore, a fundamental issue to overcome with CD ROM business cards involves directing the prospective client back to the person (i.e., the agent or representative) who gave them the card in the first place. Merely relying upon that person's name is not enough, which they may utterly forget.

There are two especially acute problems associated with personalized types of CD ROM business cards that arise as a result of the need to direct “traffic” to the agent who distributed the card.

The first is that ordering a small quantity of personalized cards (i.e., CD disks) is expensive. It is much less expensive to order a large quantity of “generic” cards, but these are presently not able to vector a user to the web site of the representative who provided the card.

The cost of production is expensive and individual representatives many not have a sufficient budget to develop their own CD business cards, especially a sufficiently well designed one. It is possible for such a budget to exceed $100,000.00. The companies are better positioned to invest such amounts of money and, as mentioned above, stand to benefit from volume discounts.

The second is that many industries must closely monitor the assertions made by their representatives. For example, those engaged in financial planning services cannot promise a rate of return on a variable type of investment and any language that might suggest or imply the making of such a promise cannot be tolerated by the parent company. The liability would be enormous, especially during periods of economic downturn.

There are strict standards involved in the financial and other industries that each representative must comply with and the parent company must ensure that such compliance is actually being accomplished.

This leads to the second problem with personalized CD ROM business cards. The parent company must examine each CD ROM business card to ensure that it is in compliance with the standards for that industry. Each industry is aware of the standards that they must comply with and with whatever regulatory body or bodies establish those standards. The problem is in verifying that each representative does not deviate from those standards in their own personalized cards or at the personal WEB site these cards vector clients to.

To do this each personalized CD ROM business card must be reviewed in detail, along with the WEB site of the representative. If a firm has many hundreds or thousands of representatives, this becomes incredibly time consuming and may even be cost and time prohibitive. It is common practice for firms to now have a team of compliance officers (i.e., web site builders) who monitor such activity, yet even they cannot possibly verify that all of their several thousand representatives, for example, are maintaining 100% compliance with the industry standards in their private CD ROM related solicitations.

Another problem that arises is that it is not possible to “re-burn” a CD ROM business card. Therefore, it is not possible to effect changes to existing cards. This is a vexing problem in the industry.

If a company orders a large quantity of generic cards and either new employees are hired or certain others leave, the question of how to add or delete those prior representatives from the large quantity of already existing generic cards is unsolved.

There is even a worse scenario that has already occurred to one degree or another. Assume that a representative has already handed out a very large quantity of generic CD ROM business cards, all of which are capable of vectoring traffic to that representative's personal WEB site. Assume also that that WEB site was reviewed by the company and was in compliance with company standards.

If that employee (i.e., representative) becomes hostile toward that firm and leaves its employ, then all traffic that uses any of those previously distributed CD ROM business cards will continue to forever be vectored to that representatives WEB site.

If that representative wishes, he may now use his personal WEB site to market products that the original firm that helped develop the business cards does not offer for sale, or he may make comments that could potentially harm the original firm. For example, he could make statements on his WEB site whereby the original firm now promises a certain yield or returns on certain investments which could create liability for the original firm.

Worse yet, he could slander the original firm on his WEB site or he might even post material that could grossly embarrass or portray the original firm in a most horrific context. He could sell his WEB site (i.e., his URL) to others who might in turn do these things, thereby substantially eliminating his own liabilities. All of these potentially damaging scenarios exist while the original firm remains unable to do anything about these already existing cards.

It is desirable to be able to modify the functionality of an already distributed CD ROM business card. It is desirable to be able to affect the vectoring of generic CD ROM business cards. Such has not been thought to be possible because these types of generic CD ROM cards are already “burned”, that is they are already formed and the data content cannot be changed.

If it were possible to affect the vectoring of generic CD ROM business cards, firms would benefit greatly. They could conceivably add vectoring capability to meet the needs of newly hired employees (i.e., representatives that are hired after the generic cards have been created).

This capability would allow firms and companies to order very large quantities of CD ROM business cards, thereby realizing even greater volume discounts.

Firms could also conceivably stop the vectoring of employees that resign or are terminated. The decrease in liability alone would make such functionality especially valuable.

Also, there is a hidden opportunity for advertising and for revenue generation from that advertising during the process of vectoring a prospect to a representatives WEB site. If a potential customer were vectored to a home page during use of the card, the opportunity to advertise the products offered by that company exists. This is valuable and the parent firms that offer these products and services are willing to pay for this advertising.

The home page, as is described in greater detail hereinafter in the instant disclosure, remains visible for a protracted period of time as certain information is entered by the client.

If a company offers either its own or the products and services of another parent firm and if the company or the other parent firm, for example, offers life insurance policies using a particular tradename or logo, that tradename or logo associated with the life insurance policies, along with the tradenames and logos of other products and services offered by the parent firm, can then also appear on the home page while the necessary information is being input by the client.

This provides an extended opportunity to inculcate the client with advertising information with helps the parent firm to more effectively advertise their products and services. As such the parent firm is willing to pay substantial advertising dollars to a service provider company that offers a home page in this manner.

If the parent firm were to pay, for example, $50,000.00 per annum for each logo or tradename to appear on the home page, the service provider company would enjoy a good source of income. The parent company that paid for this advertising would also enjoy increased sales as a result of the advertisements that appear on the home page.

There are also other possibilities for revenue generation. If a company were to offer a solution to these problems, then many other firms would want to avail themselves of this solution. The service provider company that offered such solution could provide it for a fee to use to other companies. It could also create or otherwise obtain (i.e., purchase from the parent firm) large quantities of generic CD ROM business cards and offer these cards for sale to individual representatives on a customized basis, charging a premium for the added value.

For example, if representative “John Smith” worked for the ACME company and wanted his own personalized CD ROM business cards, he could contact the service provider company that sold customized versions of the generic CD ROM business cards of ACME. That company could silk-screen on the customized cards John Smith's name and other necessary information, for example, an employee ID number that was assigned by ACME upon hiring Mr. Smith. The service provider would also handle the channeling or vectoring requirements.

If the provider company purchased large quantities of these generic cards for a few cents each, and if the silk-screening process added a few additional cents to each “customized” card, but did not affect in any way the content of the generic card, these cards could then be sold to the individual representatives at enormous profit, for example, at about $2.00 or more per card. The representative would see much added value and would gladly pay for these cards. For him to buy three-hundred cards would cost him, perhaps $600.00 dollars but when compared to the cost of designing a truly custom card on his own is considered, the savings to him are enormous.

It is also easy. All the representative must do is contact the provider company that offers the customization service, provide the URL of his own WEB site and his ACME identification number and state the number of cards he wants and pay for them. Shortly thereafter he receives the customized cards in the mail. When played, these customized cards ideally show a generic presentation of Acme's products and services and conclude by vectoring the prospect to a home page which, in turn, vectors the prospect to the WEB site (i.e., the URL) of the representative. The representative sees the silk-screening that shows his name and his ACME identification number on both the card and on the packaging. He feels the cards are well worth the money.

Yet the company that provides these cards at say ten cents total per card has an out-of-pocket cost of only $30.00 and ends up realizing a net profit of $570.00 on this order of three-hundred customized cards. Even if the cost, including all labor and shipping rose to $60.00 for this order, the service provider company would still realize a profit of $540.00 on this one order. Multiply this times thousands of representatives that work for ACME and the potential for profit becomes clear, especially when thousands of ACME type companies utilize this approach.

On top of the revenue from the sale of customized cards direct to the representatives is the advertising revenue described hereinabove that is derived by providing the logos and trademarks on the home page and also the administrative and service fees that are charged to ACME by the service provider company for maintaining the home page and data base (that does the vectoring, adds new employees, and deletes terminated employees from its data base).

Another potential problem relates to the packaging of any customized CD ROM business cards and how this packaging can be used to advantage while the cards are in use. If the card is in active use, it is disposed in a CD ROM drive of a computer and therefore it is not convenient to obtain any custom information off of the disk itself which may have to entered into the computer.

It is desirable to also include the custom information fields repetitively on the covering or on the container that contains the disk for use when the disk is itself in active use. Besides being convenient for the client, this also provides yet another way for the representative to further advertise himself, especially if the card and cover should somehow become separated from each other.

Another potential problem concerns changes in the URL (i.e., the WEB site) of the representative. For whatever reason a representative may either change or lose his URL. If the URL of the representative is “burned” into the generic card, there is no way to correct for changes that may occur in the URL of the representative after he obtains the generic cards that have been customized for his use.

If he loses his URL, all of the generic customized cards he has distributed (or has available to distribute) will send prospective clients to a WEB site that is no longer his. Clearly, this would be disastrous and counter to the purposes of obtaining and distributing the cards in the first place. Representatives who purchase generic cards and have these cards customized need a way to handle these types of problems when they occur.

There is a further need relating to CD ROM business cards as well and that includes creating prospect lists and of sending the correct information or the correct follow-through person to contact a prospective client.

When a prospective client uses (i.e., plays back) a generic CD ROM business card, there is a need to vector that prospective client to the proper products and services that are available. The prospective client may be interested, for example, in life insurance policies. It is possible the prospective client may be interested in establishing educational funding options for their children or perhaps in retirement fund options.

Clearly, if the prospective client is interested in retirement funding because presumably he or she is of advancing years, it would be damaging to send the prospective client information on educational funding when, quite possibly, their children are already grown. There may even be trauma in the prospective client's life concerning children. The prospective client may have lost a child through death or may have wished for children but never been able to have any. Clearly, the correct way to establish a positive relationship with prospective clients is by sending them the types of information that they are interested in receiving and making certain not to send them material that they are not interested in receiving.

It is desirable for a parent company to glean information about the prospective client (also sometimes known and referred to as a “prospect”), in particular what products and services they are interested in.

Furthermore, the parent company needs a way to vector the prospective client to obtain additional information about the specific product or service that they are interested in. If the client wants information about life insurance options, the parent company certainly does not wish to send (i.e., vector) the prospect to any information that may not be relevant. If the prospect is forced to wade through non-relevant information he or she may lose interest and abandon the quest, thereby losing potential sales for the parent company.

Accordingly, there is a need to be able to vector a prospect using a CD ROM business card to that information which they desire and also to obtain further information about the prospect and his or her needs so that when any additional information is sent or if any follow up telephone calls are made (if a phone number can be obtained) it is relevant to the needs of the prospect.

Another related need involves tracking the efficacy of advertising. It is desirable for a parent company to be able to track which CD ROM business cards yield the greatest return (i.e., number of “hits”). That way the parent company can modify their advertising to maximize efficacy and minimize cost.

Accordingly, there exists today a need for a system product and method for CD ROM business cards that helps to ameliorate the disadvantages mentioned hereinabove while providing advertising and other revenue-making opportunities.

Clearly, such a system product and method would be especially useful and desirable.

2. Description of Prior Art

CD ROM business cards and methods for making and using them are, in general, known. While the structural arrangements of the above known types of devices, at first appearance, may have similarities with the present invention, they differ in material respects. These differences, which will be described in more detail hereinafter, are essential for the effective use of the invention and which admit of the advantages that are not available with the prior devices.

### OBJECTS AND SUMMARY OF THE INVENTION

It is an object of the present invention to provide a system product and method for CD ROM business cards that allows for the use of generic cards.

It is also an important object of the invention to provide a system product and method for CD ROM business cards that allows for the indefinite use of generic cards.

Another object of the invention is to provide a system product and method for CD ROM business cards that can vector a prospect to the URL (WEE site) of a representative that is hired after the generic CD ROM business cards have been made.

Still another object of the invention is to provide a system product and method for CD ROM business cards that is adapted to stop the vectoring of a prospect to the URL (WEB site) of a representative that is terminated or quits after the generic CD ROM business cards have been made.

Still yet another object of the invention is to provide a system product and method for CD ROM business cards that is adapted to advertise the products and services of a parent company on a home page that is visible to a prospective client (i.e., a prospect).

Yet another important object of the invention is to provide a system product and method for CD ROM business cards that can verify the current standing of an alleged employee with a parent company.

Still yet another important object of the invention is to provide a system product and method for CD ROM business cards that inform a prospective client that a particular representative who handed out the card is no longer employed by the company.

A first continuing object of the invention is to provide a system product and method for CD ROM business cards that can change the vectoring of a client from a certain URL (i.e., website) to another website as desired.

A second continuing object of the invention is to provide a system product and method for CD ROM business cards that can change the vectoring of a client from a certain URL (i.e., website) to the website of a parent company as desired.

A third continuing object of the invention is to provide a system product and method for CD ROM business cards that is adapted to take generic cards and silk-screen the cards so as to include other desired information.

A fourth continuing object of the invention is to provide a system product and method for CD ROM business cards that is adapted to take generic cards and silk-screen the cards so as to include the name and an ID number of a representative (assigned by the employer of the representative for whom the generic cards apply).

A fifth continuing object of the invention is to provide a system product and method for CD ROM business cards that is adapted to silk-screen on the enclosures that are adapted to contain the cards desired information.

A sixth continuing object of the invention is to provide a system product and method for CD ROM business cards that is adapted to silk-screen on the enclosures that are adapted to contain the cards the name and an ID number of a representative (assigned by the employer of the representative for whom the generic cards apply).

A seventh continuing object of the invention is to provide a system product and method for CD ROM business cards that is adapted to track the efficacy of advertising by monitoring the number of hits that occur at a home page for a particular ID number.

An eight continuing object of the invention is to provide a system product and method for CD ROM business cards that is adapted to improve the efficacy of advertising by vectoring a prospect from a generic home page to a plurality of pages that more specifically address the products and services that are available.

A ninth continuing object of the invention is to provide a system product and method for CD ROM business cards that is adapted to improve the efficacy of advertising by requesting a prospect to input information about the prospect that is useful in establishing a relationship with the prospect (i.e., information that can help contact the prospect).

A tenth continuing object of the invention is to provide a system product and method for CD ROM business cards that is adapted to improve the efficacy of advertising by vectoring a prospect from a more generic home page to any of a plurality of pages that more specifically address the products and services that are available and are of interest to the prospect and of providing an opportunity for the prospect to input additional information about himself (or herself).

An eleventh continuing object of the invention is to provide a system product and method for CD ROM business cards that is adapted to improve the efficacy of advertising by vectoring a prospect from a more generic home page to any of a plurality of pages that more specifically address the products and services that are available and are of interest to the prospect and of tracking the path taken by the client.

A twelfth continuing object of the invention is to provide a system product and method for CD ROM business cards that is adapted to improve the efficacy of advertising by creating a prospect-list based on input taken from a prospect and of providing that information to a parent company.

A thirteenth continuing object of the invention is to provide a system product and method for CD ROM business cards that is adapted to improve the efficacy of advertising by creating a prospect-list based on input taken from a prospect from a home page and of providing that information to a parent company.

A fourteenth continuing object of the invention is to provide a system product and method for CD ROM business cards that is adapted to improve the efficacy of advertising by creating a prospect-list based on input taken from a prospect after the prospect has been vectored to a page of specific products and services that the prospect is interested from a home page and of providing that information to a parent company.

A fifteenth continuing object of the invention is to provide a system product and method for CD ROM business cards that is adapted to improve the efficacy of advertising by creating a prospect-list based on input taken from a prospect after the prospect has been vectored to a page of specific products and services that the prospect is interested from a home page and of providing that information to a parent company, at least a portion of the information that is gleaned being determined by inference by noting and recording the path (i.e., the vectoring from the home page) that the prospect selects.

Briefly, a system product and method for CD ROM business cards that is constructed in accordance with the principles of the present invention has a server that is accessible over the Internet by a Parent Company, a plurality of representatives, a Service Provider, and a plurality of prospects (i.e., clients). The clients gain access to a home page of the server while playing a CD ROM business card on their Internet-accessible computer. The server includes access to a data base. The server, data base, and home page are operated and maintained by the Service Provider who also furnishes customized CD ROM business cards for representatives of the Parent Company. The customized cards are generic cards that automatically vector all of the clients to the same home page after the client has viewed a generic sales presentation of the Parent Company that is included on the CD ROM business card. The Service Provider customizes the generic cards by silk-screening (i.e., printing) on the CD ROM business cards the name of the representative and an ID number of the representative. The ID number is assigned to the representative by the Parent Company and the representative furnishes the Service Provider with his ID number when he orders cards from the Service Provider, typically for a fee. The home page that the Service Provider maintains may include advertising, if desired. The home page is interactive requiring each client to manually enter (i.e., type) the ID number of the representative who gave him or her the CD ROM business card, the ID number appearing on the CD ROM business card. This information is verified by the Service Provider by comparing it with a file of valid employee ID numbers provided by the Parent Company and if the ID is acceptable, it is then used to vector the client to a personal WEB site of the representative, the representative having earlier provided the URL of his personal WEB site to the Service Provider. The Service Provider informs the Parent Company of the URL that is provided to the Service Provider by the representative at the time he or she orders a plurality of customized business cards. The Service Provider subsequently obtains confirmation from the Parent Company of the WEB site's acceptability by the Parent Company prior to enabling vectoring to it (i.e., the representative's WEB site) from the home page and prior to silk-screening the order for customized cards by the representative. Confirmation can occur in any manner although email exchanges are preferred. Changes in vectoring from the home page are accomplished by the Service Provider as needed thereby permitting mass production of Generic CD ROM business cards for each Parent Company. The Generic cards maintain utility over time because they are able to enjoy updated functionality at any time without the need to change any of the data that is contained in the card itself.

### BRIEF DESCRIPTION OF THE DRAWINGS

FIG. 1 is a flowchart of a system product and method for CD ROM business cards involving the parent company and the representative.

FIG. 2 is a flowchart of a system product and method for CD ROM business cards involving use by a prospective client.

FIG. 3 is a block diagrammatic view of a portion of a system product and method for CD ROM business cards.

### DETAILED DESCRIPTION OF THE INVENTION

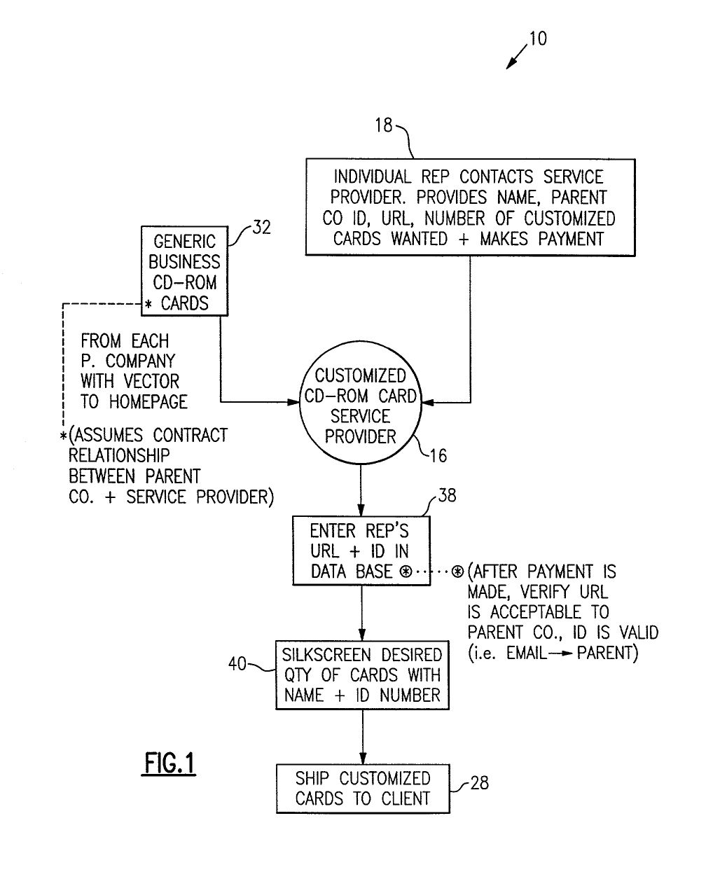

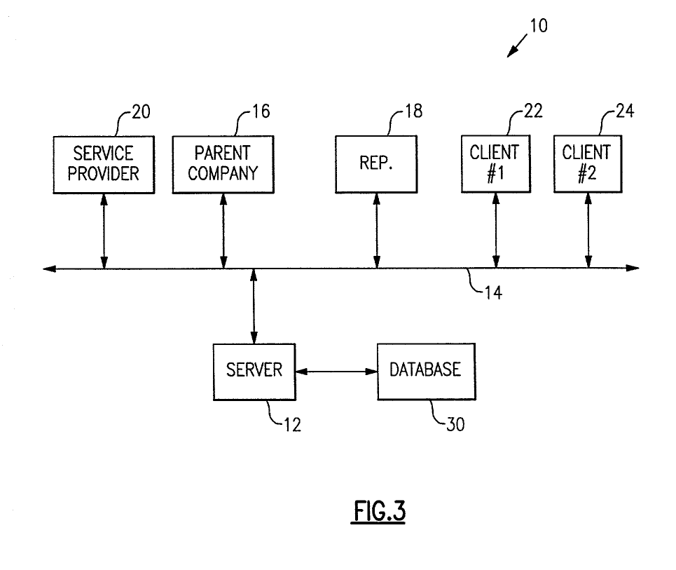

Referring to all of the FIG. 1-3 drawings on occasion is shown, a system product and method for CD ROM business cards, identified in general by the reference numeral 10.

It is important to note that as used herein the term “CD ROM business card” is intended to include any type of CD ROM that can be used (i.e., played) on the CD ROM drive of a personal computer. As such, regular types of CD RO~s are included as well as are custom shaped CD ROMs. It is possible to create CD ROM business cards that are of a non-standard size and shape (i.e., configuration). Often, they are smaller than standard sized CD ROMs and they may be oddly shaped or they may resemble a conventionally sized (length by width) “paper” business card. All such types of CD ROMs are anticipated by the instant invention and are included herein.

A server 12 is accessible over an Internet 14 (or Intranet) by a Parent Company 16, any of a plurality of representatives 18, a Service Provider 20, and a plurality of prospects (i.e., shown as a first client 22 and a second client 24).

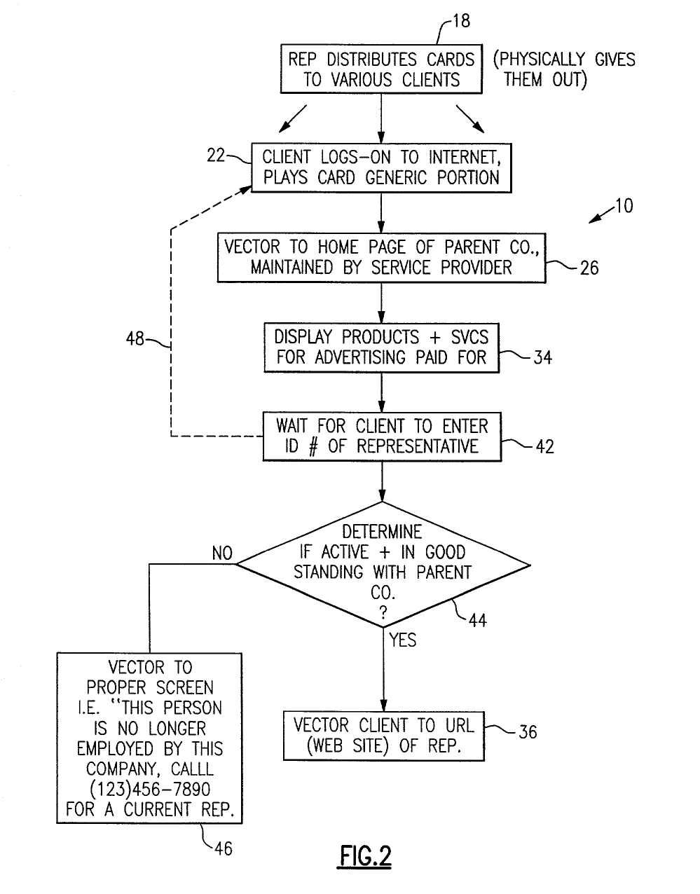

The clients 22, 24 gain access to a home page 26 (see FIG. 2) that is created and maintained by the server 12. The client plays a customized CD ROM business card 28 (see FIG. 1) on their Internet-accessible computer (not shown). The server includes access to a data base 30, either directly or over the Internet 14.

The server 12, data base 30, and home page 26 are operated and maintained by the Service Provider 20.

The Service Provider 20 creates the home page 26 to satisfy the requirements of the Parent Company 16. If the Parent Company 16 wishes to include advertising in the form of logos or trademarks of the products and services they provide, they may contract with the Service Provider 20 to do so.

All of the customized CD ROM business cards 28 contain a home page URL (the same URL) that vectors the clients 22, 24 to the same home page 26 regardless of any customization that occurs to the card.

The Service Provider 20 also creates and supplies the customized CD ROM business cards 28 for the individual representatives of the Parent Company who want them. Each customized card 28 is made from a generic card 32 without altering any of the data content of the generic card 32.

The mechanism of customization of the generic cards 32 into the customized cards 28, unique to each representative 18, is described in greater detail hereinafter.

After the clients 22, 24 have viewed a generic sales presentation by the Parent Company 16 that appears on all of the customized cards 28 as well as on all of the generic cards 32, the clients 22, 24 are automatically vectored to the same home page 26.

It is important to note that the Parent Company 16 contracts with the Service Provider 20 who, for a fee, constructs the home page 26 for the Parent Company 16 according to the needs and desires of the Parent Company 16.

Other parent companies (not shown) will also contract with the Service Provider 20 who will maintain other home pages (not shown) for the other parent companies as well.

Clearly, each of the different home pages, being for different companies, will have different company URL's. Each home page is uniquely created and maintained for each parent company by the Service Provider 20.

Similarly, the Parent Company 16, as well as all of the other parent companies, must include their own unique company URL in their own generic CD ROM business cards (and also provide same to the Service Provider 20) so that their own clients will be vectored to the proper home pages of the various parent companies.

The Service Provider 20 customizes the generic cards 32 by silk-screening (i.e., printing) on the CD ROM business cards the name of the representative 18 and an ID number of the representative 18. There is no difference in data content between the generic cards 32 and the customized cards 28. Only the exterior of the customized cards 28 is affected to include the representative's 18 name and ID number.

The ID number is assigned to the representative 18 by the Parent Company 16 and the representative 18 furnishes the Service Provider 20 with his unique ID number when he orders the customized cards 28 from the Service Provider 20, typically for a fee that he (the representative 18) pays to the Service Provider 20.

The representative 18 decides how many customized cards 28 he wishes to order at any given time from the Service Provider 20. The Parent Company 16 typically will provide a quantity of the generic cards 32 that they have had created to the Service Provider 20.

Alternately, the Parent Company may elect to contract further with the Service Provider 20 to have the Service Provider 20 create the generic cards 32 for the Parent Company 16.

The home page 26 that the Service Provider 20 maintains may include advertising 34, if desired by the Parent Company 16.

Their may also be a hierarchy of various parent companies (not shown) whereby the Parent Company 16 may be displaced at a lower point in the hierarchy and may be obliged to display advertising on the home page 26 of the products and services of any parent company that it represents which is higher in the hierarchy of companies.

The advertising 34 may include any desired text messages or it may include the logos or trademarks or both of any of the authorized products and services that are available.

It is important to note that the home page 26 is in reality a screen that appears on the computer of the clients 22, 24 when they are viewing the customized cards 28.

If the first client 22 received his customized card 28 from the representative 18, the first client 22 is vectored to and sees the same home page 26 as does the second client 24 who may have received a different customized card (not shown) from another representative, the other representative also being an employee of the Parent Company 16.

It is also important to note that to the clients 22, 24 the home page 26 appear to be part of the data content of the generic cards 32 because the client 22, 24 is automatically vectored to the home page 26 over the Internet 14 using the company URL.

Therefore, the home page 26 appears to the client 22, 24 as an extension of the presentation that is provided by the customized card 28 that he or she is viewing.

The home page 26 is an interactive screen requiring the client 22, 24 to manually enter (i.e., type) the ID number of the representative 18 who gave him or her the customized CD ROM business card 28.

The unique ID number of the representative 18 appears only on the customized CD ROM business cards 28 that he orders from the Service Provider 20. The ID number is mandatory information which must appear on the customized cards 28. The name of the representative 18 and any other information, for example the telephone number of the representative 18, can also be printed (i.e., silk-screened) on the customized cards 28.

It is also desirable to print the desired information on any sleeve (not shown) or container (not shown) that is used to house the customized cards 28 for redundancy and also so the clients 22, 24 do not have to remove the CD ROM from their computer drives to obtain this information.

If desired, the home page 26 can also include a text message as to where to obtain the necessary information that must be entered which, at a minimum, is the ID number of the representative 18. The name of the representative 18 may also be required information to enter while at the home page 26.

Another potential benefit provided is the ability to track the distribution of customized cards 28 and verify the efficacy of various advertising (i.e., customized card 28 dissemination strategies). For example, the customized cards 28 containing a particular ID number may be distributed according to a particular demographic or they may be mass mailed and the number of “hits” using that ID number tracked and recorded by the Service Provider 20. This information has added value and can be sold to either the representative 18 or to the Parent Company 16.

A different ID number can then be assigned to the same representative who distributes these cards in a different manner, perhaps face to face and their efficacy can be tracked and compared with other distribution strategies. It is also possible to embed a code using a particular field in the ID number that is assigned by the Parent Company 16 which determines how those cards will be distributed.

The ID number and any other information that is entered by the client 22, 24 while at the home page 26 is verified by the Service Provider 20 by comparing it with a file of valid employee ID numbers that are provided ahead of time to the Service Provider 20 by the Parent Company 20.

If the ID number and other data entered is acceptable, it is then used to vector the client to a personal WEB site 36 of the representative 18.

The representative 18 will have earlier provided the URL of his personal WEB site 36 to the Service Provider at the time he or she orders the customized cards 28.

The representative 18 is of course responsible to maintain his own WEB site 36.

The Service Provider 20 then informs the Parent Company 16 of the representative's 18 URL. This is done at or shortly after the Service Provider 20 is provided with this information by the representative 18. Normally, this will occur when the representative 18 places an order for a quantity of the customized business cards 28 from the Service Provider 20.

The Service Provider 20 subsequently waits to obtain confirmation from the Parent Company 16 that the representative's WEB site 36 is acceptable to the Parent Company 16. The Service Provider 20 will not enable the server 12 to vector the client 22, 24 to the representative's WEB site 36 prior to receipt of such confirmation from the Parent Company 16.

The Parent Company 16 may utilize any of a variety of ways to determine compliance and therefore acceptability of the representative's WEB site 36.

For example, the representative's WEB site 36 may itself be built and maintained by another provider (not shown) that is known to the Parent Company 16 to construct the representative's WEB site 36 in compliance with any industry or applicable regulatory standards that are in existence.

Confirmation by the Parent Company 16 is required prior to completion of the order that is being placed by the representative 18.

After confirmation has occurred the Service Provider 20 will complete the silk-screening of the order for the customized cards 28 by the representative 18 and will ship them to the representative 18 after payment is also made.

Confirmation can occur in any manner, such as by telephone or mail, although email exchanges over the Internet 14 are preferred because confirmation from the Parent Company 16 may be available instantaneously and can therefore be accomplished while the order for the customized cards 28 is being taken by the Service Provider 20.

Obviously, orders for the customized cards 28 can be taken in any manner as well, including by mail, telephone, or email over the Internet 14.

It is possible to accomplish any desired change in vectoring from the home page 26 by the Service Provider 20. For example, if the representative 18 resigns or is terminated, his ID number is deleted from the file provided by the Parent Company 16. The Service Provider 20, comparing the ID number to that file, becomes unable to vector the client 22, 24 to the representative's WEB site 36 once his ID number has been deleted from the file that the Service Provider is using.

This prevents the representative 18, should he become hostile toward the Parent Company 16, from slandering or embarrassing the Parent Company 16 in any way at the representative's WEB site 36. The Parent Company 16 is able to control all vectoring from their generic 32 as well as from the customized cards 28 for all time by cooperation with the Service Provider 20.

Similarly, a new hire (not shown) is assigned a new ID number and the new hire contacts the Service Provider 20 to order new hire customized cards (not shown) with the new ID number printed thereon. The Service Provider 20 after receiving the URL for a WEB site of the new hire and confirmation of its acceptability from the Parent Company 18 is able to vector new clients (not shown) the hew hire's WEB site once the new clients enter the new hire's ID number at the same home page 26.

Other changes may be accomplished by the Service Provider as needed, for example changing the URL of the representative 18 to access a new personal WEB site (not shown) that he has had created (and which the Service Provider 20 has received confirmation of from the Parent Company 16).

Accordingly, the Parent Company 16 is free to obtain large quantities of the generic cards 32 knowing that any and all changes in vectoring can be accomplished. Furthermore, the Parent Company 16 knows that vectoring to the representative's WEB site 36 will occur only to sites that the Parent Company 16 has itself approved of.

This eliminates much liability for the Parent Company 16. The Parent Company 16 knows that for as long as the generic advertising that is on the generic cards 32 remains valid, the generic cards 32 will be functional. Accordingly, they will order large quantities of the generic cards 32 at low cost per card.

Referring now in particular to FIG. 1, it is shown how the generic cards 32 are provided to the Service Provider 20 along with information by the representative 18.

The representative's URL and ID number 38 are entered into the data base 30, the customized cards 28 are silk-screened 40, and are then mailed to the representative 18 after his URL has been first confirmed by the Parent Company 16. His customized cards 28 will function properly only if his ID number is present on a file of valid ID numbers that are provided to the Service Provider 20 by the Parent Company 16.

Referring now in particular to FIG. 2, the distribution cycle and subsequent use of the customized cards 28 is shown.

The representative 18 provides the client 22 with a customized card 28. The client 22 plays the card on his Internet 14 accessible computer which, after the generic sales presentation is complete, vectors the client 22 (all clients 22, 24 regardless of who is the representative or how the customized cards differ) to the same home page 26.

The client 22 is exposed to any advertising 34 and is asked to enter the ID number of the representative 18. The server 12 waits 42 for this to occur.

Once the ID number (and any other required data) has been entered by the client 22, the server 12 determines if the representative 18 remains in good standing 44 by comparing the ID number with the file of valid ID numbers supplied to the Service Provider 20 by the Parent Company 16.

If the ID number is valid, the client 22 is vectored to the representative's WEB site 36 where the sales presentation continues in compliance with industry standards, yet in direct relationship with the representative 18 who is desirous to close the sale and receive credit or commission for the sale.

As long as the representative 18 is an employee of the Parent Company 16 in good standing, all of the clients 22 who use his customized cards 28 are eventually directed to the representative's WEB site 36 thereby ensuring that the client 22 must do business with the representative 18 and not with any other representative (not shown).

If the comparison 44 does not show the representative 18 to be in good standing, the client 22 is then vectored to an alternative screen 46. The alternative screen 46 is tailored to display any appropriate message depending upon the nature of the events that preceded the representative's 18 ID number removal from the valid file.

If the representative resigned, for example, the alternative screen 46 might include a text message that informs the client 22, “This person is no longer employed by this company. Please call telephone number (xxx) 123-4567 or log onto ‘www.listofreps/parentcompany.com’ for a list of representatives in your area.”

The alternative screen 46, upon input of the ID number from the client 22, can thereby provide a seamless way to instantly vector the client 22 to wherever the parent company wishes, thereby giving no cause for concern that anything has changed or is amiss with the parent company.

In addition, the home page can provide several options for the client 22 to choose from depending upon the products and services that are available from the Parent Company 16.

For example, one option might be to obtain further information concerning life insurance options, another concerning educational funding options, and another concerning retirement funding options. The client 22 can select (i.e., “click”) on the option he is interested in.

The Service Provider 20 that creates and manages the home page also creates and manages a plurality of subsequent pages that the client 22 is then vectored to after having selecting, from the home page, the product or service that the client 22 is interested in.

The Service Provider 20 tracks the vectoring that takes place. If the client 22 were asked to input information while on the home page, and if the client 22 then vectors to a subsequent page, the Service Provider 20 knows that the client is interested in certain of the products or services offered by the Parent Company 16 by tracking the path (i.e., which subsequent page) the client 22 goes to.

The Service Provider 20 is then able to create a “prospect list” that includes the information gathered from each of the clients 22 and the types of products and services that each of the clients 22 is interested in.

This information is derived from the data that is actually input by each client 22 and also by inference. If the client 22 goes to a subsequent page that is about educational funding, it can well be assumed that is what the client 22 is interested in, even without further query or input on the part of the client 22.

The Service Provider 20 is then able to provide the prospect list to the Parent Company 16, presumably for an additional fee for this service. Clearly, the server 12 and the data base 30 are used with proper support software to implement this capability.

If desired, the prospect list can be “emailed” to the Parent Company 16 or it can be send by FAX or regular mail, as desired. If it is emailed, then a subscription service that automatically tracks prospect information and which sends it to the Parent Company 16 for follow up activity (by the Parent Company 16) can automatically be sent at minimum overhead to the Service Provider 20.

Obviously, if the desired information about the client 22 is not input while the client 22 is on the home page, it can be input by the client 22 when the client 22 is at any of the subsequent pages. Any of the subsequent pages can also be interactive types of screens.

Accordingly, the Parent Company 16 is able to track the efficacy of their solicitations. The Parent Company 16 can also determine, as mentioned hereinabove, by a study of the ID numbers that are input, which of the CD ROM business cards are most effective (i.e., which ones get used).

If one or more of the numbers that comprise the ID number includes a code that specifies how that CD ROM business card is distributed or where, then by the Service Provider 20 tracking the “hits” as they relate to the encoded information, the Parent Company 16, upon receipt of this information, can optimally adjust their distribution policies for their CD ROM business cards.

All of these features and abilities are available with generic types of CD ROM business cards. The Parent Company 16 is free to change the way it does business and by simple changes made to the home page by the Service Provider 20, the products, services, even the look and feel of the Parent Company 16 can instantly change without changing anything about the already existing generic CD ROM business cards.

For example, the Parent Company 16 may offer a special incentive to each of the clients 22 by sending a package of three golf balls to the client 22 merely for the client 22 using the CD ROM business card and going to the home page and entering certain information (the ID number, name, address, phone, etc.).

However, if the Parent Company 16 rescinds the “golf ball” offer or decides to offer tennis balls instead, the Service Provider 20 can adjust the home page accordingly to reflect the wishes of the Parent Company 16 and these changes are accomplished rapidly.

This eliminates the risk to the Parent Company 16 arising from the possibility that old CD ROM business cards (i.e., disks) remain out in the world indefinitely and that sometime, perhaps even years later, a new client will be use it and demand the free golf balls, as promised. The new client who now uses the same pre-existing CD ROM business card that once led him to a home page that offered free golf balls is now taken to a home page that offers free tennis balls or perhaps nothing at all, if the Parent Company 16 so chooses.

Once again the Parent Company 16 is able to use its generic CD ROM business cards indefinitely while being able always to maintain or upgrade the home page accordingly.

If the Parent Company 16 decides to change its image and wants the home page to reflect this change, perhaps to show a new look and feel, or new product offerings, these changes can similarly be accomplished by the Service Provider 20 without affecting any of the generic CD ROM business cards that have already been distributed and are currently in use or even those that are available for future distribution.

If a corporate merger were to occur, for example, the Parent Company 16 might have many new products and services to offer. The old generic CD ROM business cards can still be used to show these new products and services because the home page will be edited to reflect any new look or feel or product or service that is desired by the Parent Company 16. Accordingly, the Parent Company 16 feels confident to order large quantities of the generic CD ROM business cards knowing that changes in specials or products or services can also be readily accomplished by the Service Provider 20.

The invention has been shown, described, and illustrated in substantial detail with reference to the presently preferred embodiment. It will be understood by those skilled in this art that other and further changes and modifications may be made without departing from the spirit and scope of the invention which is defined by the claims appended hereto.

Many changes are possible. For example, referring again to FIG. 2 is shown a dashed line identified in general by the reference numeral 48. The dashed line 48 shows that any desired input from the client 22 can be obtained during actual playback of the CD ROM business card prior to vectoring to the home page. The information that is input by the client 22 during the sales presentation of the generic, CD ROM business card is remembered by the personal computer and is included in the bit stream of communications that vector the client 22 to the home page. The server 12 of the Service Provider 20 captures the information that was input earlier, thereby eliminating the need to do this at the home page. For certain applications, the Parent Company 16 may prefer to obtain information about the client 22 as soon as possible and not wait until the client 22 is vectored to the home page.

What is claimed is:

1. A system for utilizing CD ROM business cards adapted for use over the Internet, comprising:
(a) a CD ROM business card adapted for use by a user; and
(b) means for transferring said user to a home page of a Service Provider over said Internet; and
(c) means for controlling the transfer of said user from said home page to a second location over said Internet.

2. The system of claim 1 wherein said CD ROM business card includes a generic type of a CD ROM business card.

3. The system of claim 1 wherein said means for transferring said user to a home page includes encoding an address of said home page on said CD ROM business card.

4. The system of claim 1 wherein said means for controlling the transfer of said user from said home page includes means for determining an identity of a person that represents a Parent Company.

5. The system of claim 4 wherein said home page is maintained by said Service Provider.

6. The system of claim 5 wherein said means for determining an identity of a person includes a data base and a server that are maintained by said Service Provider and wherein said server is used to create said home page and wherein said home page includes an interactive screen and wherein said server includes means for accepting an ID number of said person.

7. The system of claim 6 including means for visibly displaying said ID number on said CD ROM business card and wherein said user is adapted to input said ID number to said server.

8. The system of claim 6 including means for visibly displaying said ID number on a container that is adapted to contain said CD ROM business card and wherein said user is adapted to input said ID number to said server.

9. The system of claim 6 wherein said server is adapted to make a comparison of said ID number with at least one file in said data base and wherein said server is adapted to take an action in response to a result of said comparison.

10. The system of claim 9 wherein subsequent to said comparison confirming that said ID number is included in said data base and that said number is assigned to said person, and that said person is an employee in good standing of said Parent Company, said action includes transferring said user to a WEB site of said person.

11. The system of claim 10 wherein said person includes a newly hired person by said parent company.

12. The system of claim 9 wherein subsequent to said comparison confirming that said ID number is not included in said data base for said parent company, said action includes transferring said user to a WEB site of said Parent Company.

13. The system of claim 12 wherein said ID number includes that of said person and wherein said person no longer represents said Parent Company.

14. The system of claim 1 wherein said home page includes means adapted to display an advertisement.

15. The system of claim 14 wherein said advertisement includes an indication of at least some of the products that are available from said Parent Company.

16. The system of claim 14 wherein said advertisement includes an indication of at least some of the services that are available from said Parent Company.

17. The system of claim 1 wherein said home page includes means adapted to vector said user to a subsequent page that includes those products and services that said user is interested in.

18. The system of claim 17 wherein said subsequent page includes means for obtaining input from said user and wherein said system includes means adapted for utilizing said input.

19. The system of claim 1 wherein home page includes means for obtaining input from said user and wherein said system includes means adapted for utilizing said input.

20. The system of claim 19 wherein said means adapted for utilizing said input includes means for creating a prospect-list, said prospect list including information about at least one prospect.

21. The system of claim 20 including means for providing a parent company with said prospect list.

22. An improvement to a CD ROM business card, the improvement comprises: including an address encoded in said CD ROM business card wherein said address is adapted to transfer a user over an Internet to a home page and wherein said home page is adapted to selectively transfer said user to a second Internet address.

23. The CD ROM business card of claim 22 wherein said home page is adapted to be maintained by a Service Provider.

24. In a method of making a CD ROM business card, the improvement comprises: providing an address encoded in said CD ROM business card wherein said address is adapted to transfer a user over an Internet to a home page and wherein said home page is adapted to selectively transfer said user to a second Internet address.
